(19) United States
(12) Patent Application Publication
(10) Pub. No.: US 2010/0039968 A1
(43) Pub. Date: Feb. 18, 2010

(54) Receiver

(75) Inventor: Andrew Papageorgiou, Lower Cambourne (GB)

Correspondence Address: FITZPATRICK CELLA HARPER & SCINTO, 1290 Avenue of the Americas, NEW YORK, NY, 10104-3800, US

(73) Assignee: CAMBRIDGE SILICON RADIO LIMITED, CAMBRIDGE (GB)

(21) Appl. No.: 12/190,903

(22) Filed: Aug. 13, 2008

(51) Int. Cl. H04B 7/00

(52) U.S. Cl. 370/310

(57) ABSTRACT

A receiver for a telecommunications system, the receiver comprising a processor (34) arranged to calculate a quality metric for part of a received signal, which quality metric can indicate whether the part of the received signal contains a Part 1 of an HS-SCCH control block, and a processor (36) for comparing the quality metric to a threshold to determine if a Part I of an HS-SCCH control block has been received, characterised in that the receiver is arranged to adjust the threshold if the processor (36) determines that an HSDPA packet has been received.

The present invention relates to a receiver for a telecommunications system and to a method of receiving a signal.

In the High Speed Downlink Packet Access (HSDPA) protocol used in third-generation (3G) mobile telecommunications systems for data transfer from a Node B to a User Equipment (UE) such as a mobile telephone handset, data is transferred in packets. A High Speed Downlink Shared Channel (HS-DSCH) is common to up to a maximum of four High Speed Shared Control Channels (HS-SCCH), which the UE monitors. This arrangement allows four separate, independent, UEs to access the common HS-DSCH. An HS-SCCH control block and its associated HS-DSCH data block constitute an HSDPA data packet.

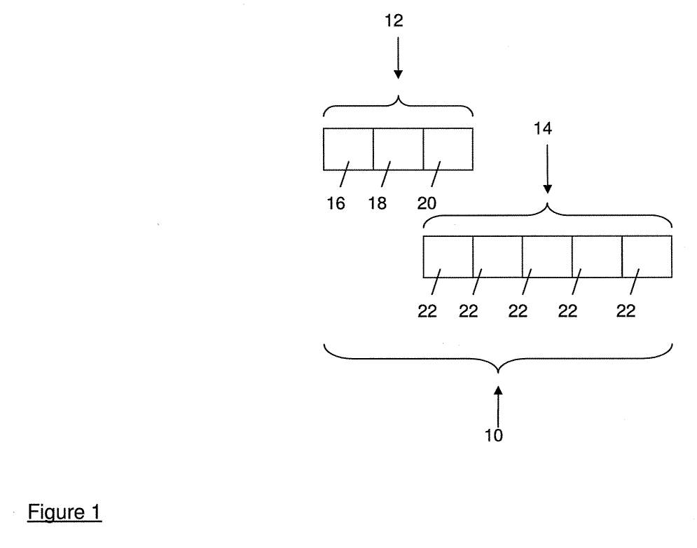

In the schematic illustration of FIG. 1, an HSDPA data packet is shown generally at 10, with the HS-SCCH control block being shown generally at 12 and the HS-DSCH data block being shown generally at 14.

For data transfer from a Node B to a UE, the UE must detect the control block 12, deduce that the control block is correct and then, using information contained in the control block 12, configure hardware in the UE to process the data block 14 associated with the control block 12. As there are up to four HS-SCCHs associated with a single HS-DSCH, the UE must monitor all four of these channels for a control block 12 which might be intended to be received by the UE.

In HSDPA, data packets are divided into time slots of equal length. The control block 12 comprises a Part I, which occupies a single time slot 16, followed by a Part II, which occupies two time slots 18, 20.

The Part II of the HS-SCCH control block 12 contains a CRC checksum, so that when a Part II has been received a CRC check can be performed to determine whether it is probable that the Part II has been received accurately. No such checksum exists in the Part I, and it is not desirable to add one, since this would increase the length of the Part I. Instead, to assess whether the Part I has been accurately received, a quality metric may be calculated by the UE receiving the transmitted signal. In one known method, a Yamamoto-Itoh (YI) algorithm is incorporated into a Viterbi algorithm being used by the UE to recover the HS-SCCH control block 12, and this YI algorithm evolves a value for a YI metric for a potential Part I yielded by the Viterbi algorithm.

If the value of the strongest quality metric calculated for the potential Part Is from the four possible HS-SCCHs exceeds a threshold, then the Part I is deemed to have been received correctly. If the threshold is set too low, there is an increased likelihood of false positives, i.e. that an incorrectly received Part I will be deemed to be correctly received, whilst if the threshold is set too high, there is an increased likelihood of false negatives, i.e. that a correctly received Part I will be deemed to have been incorrectly received.

When a control block 12 commences in an HS-SCCH channel, the data block 14 in the associated HS-DSCH commences two time slots later, after the Part I of the HS-SCCH control block 12 has been received but before the Part II of the HS-SCCH control block 12 has been completely received. The hardware employed in the UE to process the data block 14 consumes a lot of power, so it is desirable not to activate it unnecessarily.

One method of preventing the hardware from being activated unnecessarily is to wait until the Part II of the HS-SCCH control block 12 is confirmed by the CRC check as having been received accurately. However, at this point the HS-DCSH data block 14 will already have commenced, meaning that some data in the HS-DSCH data block will be missed. This problem can be addressed by including memory buffers to hold the contents of the HS-DSCH channel, but this requires additional silicon area within the UE.

Alternatively, as the Part I is received a full time slot before the HS-DSCH data block 14 commences, the quality metric calculated for the Part I may be used to control the activation of the processing hardware within the UE. Thus, if the quality metric betters the threshold, the processing hardware within the UE may be activated. A disadvantage of this approach, however, is that the threshold must be selected very carefully to minimise the risk of unnecessary activation of the processing hardware caused by false positive results of the metric threshold comparison, whilst also minimising the risk that data will be missed and will thus have to be re-transmitted in the event that a false negative result is output by the metric threshold comparison.

According to a first aspect of the present invention, there is provided a receiver for a telecommunications system, the receiver comprising a processor arranged to calculate a quality metric for part of a received signal, which quality metric can indicate whether the part of the received signal contains a Part 1 of an HS-SCCH control block, and a processor for comparing the quality metric to a threshold to determine if a Part I of an HS-SCCH control block has been received, characterised in that the receiver is arranged to adjust the threshold if the processor determines that an HSDPA packet has been received.

In the event that a first HSDPA packet has been received, there is an increased likelihood that the next signal received by the receiver will be an HSDPA packet, and because of this increased likelihood the test for whether the next signal received is an HSDPA packet can be made less stringent. Thus, the threshold to which the metric is compared can be adjusted, thereby reducing the likelihood of a false negative result, which would cause data to be missed.

Preferably, the threshold is reset to a default value if no HSDPA packet is determined by the processor to have been received for a predetermined period of time.

The receiver may further comprise a counter for counting down from a predetermined value, the counter being reset to the predetermined value if the processor determines that a Part II of a HS-SCCH control block has been received.

The processor for calculating the quality metric may calculate the quality metric using a Yamamoto-Itoh (YI) algorithm.

According to a second aspect of the invention, there is provided a method of receiving a signal, the method comprising calculating a quality metric for part of the received signal, which quality metric can indicate whether the part of the received signal contains a Part 1 of an HS-SCCH, comparing the quality metric to a threshold to determine if a Part 1 of an HS-SCCH has been received, and adjusting the threshold if it is determined that an HSDPA data packet has been received.

The threshold is preferably reset to a default value if no HSDPA packet is determined to have been received for a predetermined period of time.

The predetermined period may be defined by a countdown which is reset to a predetermined value if it is determined that a Part II of a HS-SCCH control block has been received.

The quality metric may be calculated using a Yamamoto-Itoh (YI) algorithm.

According to a third aspect of the invention, there is provided a computer program for performing the method of the second aspect.

Embodiments of the invention will now be described, strictly by way of example only, with reference to the accompanying drawings, of which

FIG. 1 is a schematic representation showing an HS-SCCH control block and an HS-DSCH data block of an HSDPA data packet; and

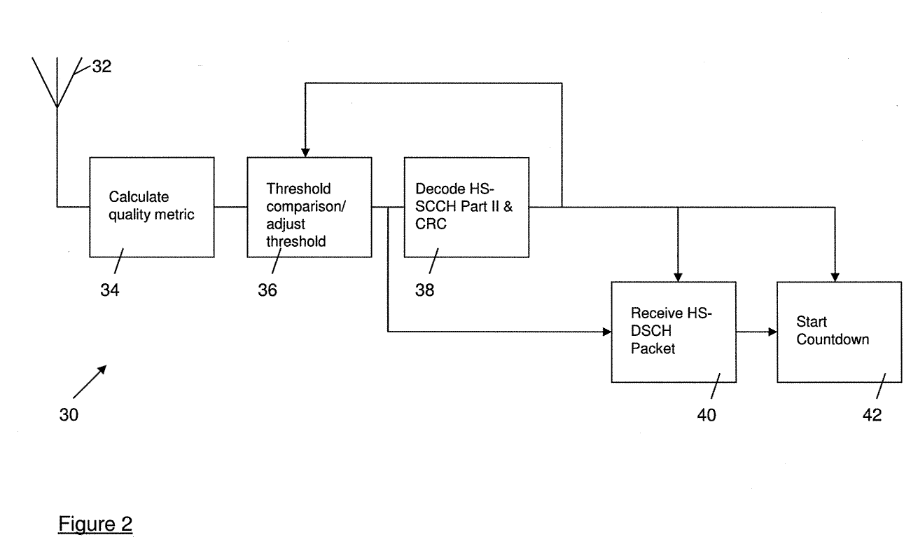

FIG. 2 is a schematic representation of components of a receiver in accordance with the present invention.

Referring first to FIG. 1, an HSDPA data packet is shown generally at 10 and comprises a HS-SCCH control channel block 12 and a HS-DSCH data channel block 14, which forms part of an HS-DSCH. As is described above, the HS-SCCH control channel block 12 comprises a Part I which occupies a single time slot 16 and a Part II which occupies the following two time slots 18, 20 of the HS-SCCH control channel block 12. For convenience, the HS-DSCH data channel block 14 is shown in this example as occupying five time slots 22, although it will be appreciated by those skilled in the relevant art that the HS-DSCH data channel block 14 may occupy more or fewer time slots.

Turning now to FIG. 2, part of a receiver architecture is shown generally at 30. It is to be understood that the functional blocks shown in FIG. 2 are for illustrative purposes only, and do not necessarily represent actual physical components of a receiver.

The receiver comprises an antenna 32, through which a signal can be received. A received signal is processed initially in a calculation unit 34 in which a quality metric is calculated, which quality metric can be used to indicate whether or not part of the received signal is likely to contain a Part I of an HS-SCCH control block of an HSDPA data packet.

The calculation unit 34 is configured to implement a Viterbi algorithm to decode the received signal, as will be familiar to those skilled in the art. In this embodiment, a Yamamoto-Itoh (YI) algorithm is incorporated into the Viterbi algorithm to evolve the quality metric as the received signal is processed by the Viterbi algorithm, although it will be appreciated that other techniques for calculating the quality metric are equally suitable.

The quality metric is passed to a threshold processing element 36 which performs a comparison of the quality metric against a threshold. If the quality metric betters the threshold the threshold processing element 36 determines that a Part I of an HS-SCCH control block has been received successfully. In this example, a Part I is deemed to have been received successfully if the metric exceeds the threshold, but of course an alternative system in which the Part I is deemed to have been received successfully if the metric falls below the threshold is also possible.

If the threshold processing element 36 determines that a Part I has been received successfully, a data processing element 38 proceeds to decode the Part II of the HS-SCCH control block. A further data processing element 40 is activated and proceeds to process the HS-DSCH data block associated with the HS-SCCH control block whose Part I has been received successfully. By activating the data processing element 40 only when a Part I is deemed to have been received successfully the power consumption of the receiver can be reduced, as the data processing element 40 is only active and consuming power when there is a reasonable probability that an HS-DSCH data block will be received and available for processing.

Once the data processing element 38 has decoded the Part II of the HS-SCCH control block, a CRC or other check is made to determine if the Part II has been received and decoded successfully. If the check returns a negative result, the Part II has not been received and decoded successfully, and the corresponding HS-DSCH cannot be successfully decoded. Thus, if the check of the Part II returns a negative result a signal is sent to the data processing element 40 to cause it to abort processing the HS-DSCH data block and to deactivate, thereby saving power.

If the check of the Part II returns a positive result, the HS-DSCH data block may still not be successfully decoded. However, the processing element is allowed to continue processing the HS-DSCH data block.

Once the data processing element 40 has processed the HS-DSCH data block a check is made to determine whether a complete HSDPA data packet has been received successfully. This check may comprise the CRC or other check of the Part II of the HS-SCCH control block, with a positive result indicating that an HSDPA data packet has been received successfully. Alternatively, a CRC or other check may be performed on the HS-DSCH data block by the data processing element 40, and it will be appreciated by those skilled in the art that other methods may be employed to determine whether an HSDPA data packet has been successfully received.

When a first HSDPA data packet has been received by the receiver, there is an increased probability that one or more further HSDPA data packets will be transmitted to the receiver, as data transmitted to a receiver via HSDPA, for example a web page transmitted to a UE, typically occupies a plurality of HSDPA data packets. Because of this increased probability that the next signal received by the receiver will be a further HSDPA data packet, the receiver can be less stringent in determining whether the next received signal is an HSDPA data packet. Thus, if the receiver determines that an HSDPA data packet has been received, it adjusts the threshold to which the quality metric of the next received signal will be compared to make it more likely that the next received signal will be deemed to contain a Part I of an HS-SCCH control channel block. Of course, adjusting the threshold in this manner increases the likelihood of false positives, i.e. received signals being deemed to contain a Part I when in fact they do not, but it also reduces the likelihood of false negatives, i.e. received signals which contain a Part I being deemed not to, thus reducing the likelihood that data packets will have to be re-transmitted.

Once all of the HSDPA data packets of a data transmission have been successfully received by the receiver, it is necessary to return the threshold to a value at which there is a reduced probability of false positives occurring, so that the receiver does not waste power in attempting to decode signals which were not intended for it.

To this end, the receiver includes a counter 42 which is pre-set to an appropriate value as soon as it has been determined that an HSDPA data packet has been successfully received (for example by a positive result of a CRC test of the Part II of the HS-SCCH control channel block, as described above). If it is not determined that an HSDPA data packet has been successfully received in the time taken to receive an HSDPA sub-frame, the counter 42 is decremented, with the threshold being reset to a default level when the counter 42 reaches zero. The initial value of the counter 42 must be selected so as to permit sufficient time for a plurality of packets in an HSDPA data burst (for example the data packets making up a web page) to be successfully received by the receiver before the count reaches zero, but not so high as to cause the receiver erroneously to process signals which were not intended for it but which, because of the adjusted threshold, have been incorrectly deemed to contain a Part I.

It is to be noted that even if the check of the Part II of the HS-SCCH control block returns a positive result a CRC or other check of the HS-DSCH data block may still return a negative result. For this reason it is preferred that the check of the Part II of the HS-SCCH control block is used to determine whether the threshold should be adjusted.

The functional blocks shown in FIG. 2 may be implemented as separate hardware components, for example as individual processors or circuits comprising discrete components. Alternatively the functional blocks may be implemented in single suitably configured processor, such as a microprocessor, ASIC, digital signal processor or the like, or in software executed by a suitably configured processor.

1. A receiver for a telecommunications system, the receiver comprising a processor arranged to calculate a quality metric for part of a received signal, which quality metric can indicate whether the part of the received signal contains a Part 1 of an HS-SCCH control block, and a processor for comparing the quality metric to a threshold to determine if a Part I of an HS-SCCH control block has been received, characterised in that the receiver is arranged to adjust the threshold if the processor determines that an HSDPA packet has been received.

2. A receiver according to claim 1 wherein the threshold is reset to a default value if no HSDPA packet is determined by the processor to have been received for a predetermined period of time.

3. A receiver according to claim 2 further comprising a counter for counting down from a predetermined value, the counter being reset to the predetermined value if the processor determines that a Part II of a HS-SCCH control block has been received.

4. A receiver according to claim 1 wherein the processor for calculating the quality metric calculates the quality metric using a Yamamoto-Itoh (YI) algorithm.

5. A method of receiving a signal, the method comprising calculating a quality metric for part of the received signal, which quality metric can indicate whether the part of the received signal contains a Part 1 of an HS-SCCH, comparing the quality metric to a threshold to determine if a Part 1 of an HS-SCCH has been received, and adjusting the threshold if it is determined that an HSDPA data packet has been received.

6. A method according to claim 5 wherein the threshold is reset to a default value if no HSDPA packet is determined to have been received for a predetermined period of time.

7. A method according to claim 6 wherein the predetermined period is defined by a countdown which is reset to a predetermined value if it is determined that a Part II of a HS-SCCH control block has been received.

8. A method according claims 5 wherein the quality metric is calculated using a Yamamoto-Itoh (YI) algorithm.

9. A computer program for performing the method of claims 5.
